(19) United States
(12) Patent Application Publication
(10) Pub. No.: US 2024/0177986 A1
(43) Pub. Date: May 30, 2024

(54) METHOD FOR DESORBING AND IONIZING OF SAMPLE MATERIAL

(71) Applicant: Bruker Daltonics GmbH & Co. KG, Bremen (DE)

(72) Inventors: Marcel NIEHAUS, Bremen (DE); Andreas HAASE, Bremen (DE)

(21) Appl. No.: 18/523,158

(22) Filed: Nov. 29, 2023

(30) Foreign Application Priority Data
Nov. 30, 2022 (DE) 102022131740

(51) Int. Cl. H01J 49/16; H01J 49/00; H01J 49/04

(52) U.S. Cl. CPC H01J 49/164; H01J 49/0031; H01J 49/0418

(57) ABSTRACT

Disclosed are methods and devices for desorbing and ionizing of sample material which is deposited on a sample support, which methods and devices use a post-desorption ionization modality with dynamic spatial alignment. Principles of the disclosure may be used in imaging ion spectrometry, for example, particularly in imaging ion spectrometry with ion generation using matrix-assisted laser desorption and ionization (MALDI).

### FIELD OF THE INVENTION

The invention relates to methods and devices for desorbing and ionizing of sample material which is deposited on a sample support. Principles of the disclosure may be used in imaging ion spectrometry, for example, particularly in imaging ion spectrometry with ion generation using matrix-assisted laser desorption and ionization (MALDI).

### BACKGROUND TO THE INVENTION

The Prior Art is explained below with reference to a specific aspect. This is not to be understood as a limitation, however. Useful developments and modifications to the invention may also be applicable beyond the comparatively narrow scope of this introduction, and will become readily apparent to practitioners skilled in the art after reading the disclosure of the invention which follows this introduction.

The MALDI method has been used for ion spectrometry analyses for a long time. In the case of ultraviolet vacuum MALDI, soluble analyte molecules are embedded in a light-absorbing, crystallizing matrix substance and are then irradiated with coherent ultraviolet light pulses. The UV light is absorbed by the crystallized matrix substance, which is then desorbed into a material cloud, and the embedded analyte molecules are desorbed along with the substance. The characteristics of the desorption process and the material cloud cause charge carriers to be formed and transferred to the analyte molecules, with the result that charged analyte molecules or analyte ions are generated. These analyte ions can then be guided and analyzed using electromagnetic fields, e.g., in the process of a mobility and/or mass analysis that sorts and detects charged molecules or ions according to their collision-cross-section-to-charge ratio or their mass-to-charge ratio.

Benefits of this established MALDI method lie in the fact that the analyte molecules are ionized very gently, with practically no fragmentation, and that the generated analyte ions have a largely uniform charge state, usually z=1. In complex samples in particular, however, it has been found that different molecule classes respond differently to the MALDI method, in particular, depending on the matrix substance used. For example, certain biomolecules are ionized such that they are sufficiently detectable, whereas other biomolecules in the ion currents that are acquired from a mixture are quantitatively underrepresented by comparison. This differing responsiveness is particularly evident in the investigation of tissue sections in imaging mass spectrometry, for example, and can limit the informational value of the acquired measurement data. It has been observed, for example, that lipids in the spectra of tissue sections may be overrepresented compared to proteins and peptides.

Some time ago, a post-desorption ionization method was therefore proposed that can increase the conversion rate of lower-concentrated molecules. The principle essentially consists in laterally transmitting an additional coherent ultraviolet light pulse into the material cloud of the MALDI desorption. This method is referred to as MALDI-2. The interaction of the light pulse with the particles in the material cloud brings about an expansion of the supply of charge carriers, which improves the ionization yield, particularly for lower-concentrated analyte molecules. But higher-concentrated biomolecules can also benefit from a post-ionization modality. Phosphatidylethanolamines (PEs), for example, are barely detected in MALDI measurements compared to phosphatidylcholines (PCs), despite the fact that both are comparably abundant in tissue. With MALDI-2, PEs are heavily ionized and are then reliably detectable in the acquired spectra.

An important publication on the MALDI-2 method is the study by Jens Soltwisch et al. (Science, 10 Apr. 2015⋅Vol 348, Issue 6231, 211-215), in which this name was coined. This study uses a wavelength-tunable post-ionization laser to trigger secondary MALDI-like ionization processes in the gas phase. An increase in the ion yield by up to two orders of magnitude is reported for numerous lipid classes, fat-soluble vitamins and saccharides that were imaged in animal and plant tissue with a 5-micrometer-wide laser spot. The pressure of the cooling gas in the ion source, the laser wavelength, the pulse energy and the time lag between the two laser pulses are described as decisive parameters for the triggering of the secondary ionization processes.

A number of prior art publications that may be relevant for the present disclosure are briefly acknowledged in the following list:

The monograph by Klaus Dreisewerd (Chem. Rev. 2003, 103, 395-425) deals with, among other things, post-ionization experiments on the characterization of the MALDI method, in particular, in Section V. Plume Dynamics.

The patent publication WO 2010/085720 A1 discloses a method and a device for the efficient measurement of an ionized MALDI desorption cloud when post-ionization methods (POSTI) are combined with a medium vacuum MALDI ion mobility orthogonal time-of-flight mass spectrometer (MALDI-IM-oTOF-MS). A related work is the article by Amina S. Woods et al. (J Proteome Res. 2013 Apr. 5; 12(4): 1668-1677).

The article by M. Niehaus et al. (Nature Methods Vol. 16, 925-931 (2019)) deals with MALDI-2 mass spectrometry in transmission mode for the imaging of cells and tissues with sub-cellular resolution.

MALDI measurements from very extensive sample material are becoming increasingly important; consider tissue sections in imaging mass spectrometry with areas in the order of magnitude of a few square centimeters or fields of very densely packed individual preparations in a high-throughput analysis, e.g., 1536 single preparations on a MALDI sample support. Measurements from sample supports loaded in this way can take a very long time; several hours or even days in the case of large tissue sections. To reduce the spectral data recording time, a dynamic operation of the MALDI desorption laser beam was proposed for the measurement procedure, combining a large number of rapid orientation changes of the desorption laser beam for the sampling of a predetermined finite area on the sample material with a few rather time-consuming adjustments of the MALDI sample support in order to move to different areas. This means that the entire surface of a sample support can be probed quicker than by simply adjusting the heavy, and therefore rather slow, translation stage that carries the sample support. An example is provided in the patent publication DE 10 2018 112 538 B3 (corresponds to US 2019/0362958 A1 and GB 2 574 709 A), in particular, with reference to FIG. 8.

Scanning of the sample support surface that exclusively uses the laser beam is subject to technical limits in that, on the one hand, the desorption laser beam must not hit the sample material at too great an angle and, on the other hand, ablated and ionized sample material must be transferred into other components of a connected analytical system via interfaces that are usually stationary. This limits the beam deflection to a distance of a few hundred micrometers between the two furthest impingement points on a predetermined finite area. A standard MALDI sample support, on the other hand, has the dimensions of a microtitration plate (127.76 millimeters×85.48 millimeters×14.35 millimeters), meaning that the available surface—even with incomplete sample loading—cannot be completely covered solely by the desorption laser beam without spatial adjustment of the sample support. Rather, a plurality of predetermined finite areas on the sample support can usually be defined on a sample support.

In view of the above discussion, there is a need for an improvement in the methods and devices for desorbing and ionizing of sample material, particularly in relation to sensitivity to weakly ionizing molecular substrates. Further objectives that can be achieved by the invention will be immediately apparent to the person skilled in the art from reading the disclosure below.

### BRIEF SUMMARY OF THE INVENTION

According to a first aspect, the present disclosure relates to a method for desorbing and ionizing of sample material deposited on a sample support, comprising: —repeatedly locally impacting sample material on the sample support using a first energetic radiation and triggering of local desorption of sample material into the gas phase above the sample support, while varying a position of the first energetic radiation relative to the sample support and aiming at a plurality of impingement points on the sample material on the sample support; —pulsed impacting the locally desorbed sample material using a second energetic radiation, which is aimed into the locally desorbed sample material, and triggering of ionization and/or increasing a degree of ionization of the locally desorbed sample material, with a direction of propagation of the second energetic radiation being in a plane that is substantially perpendicular to a surface normal of the sample support and positioned above the sample support, and with a focus position and/or beam waist position of the second energetic radiation being re-aligned such that it is positioned substantially opposite a current impingement point at the sample material on the sample support; and —transferring of ionized sample material, originating from the locally desorbed sample material which has been impacted with the second energetic radiation, into an ion-processing device.

The height of the plane above the sample support may be in the range of 300-1000 micrometers, and particularly 500 micrometers. The position of the plane above the sample material and sample support is preferably substantially constant, e.g., with rather small deflections, by a few degrees, of the alignment of the first energetic radiation. In certain embodiments, the height of the plane above the sample material and sample support may be changed, e.g., increased or decreased, temporarily and for a short period of time. With desorption and ionization in a vacuum, the environment where the sample support with sample material is kept may be maintained at a pressure in the range of 0.5-10 hectopascal, e.g., by means of suitably connected pumps. A timespan or time lag between the triggering of the first energetic radiation and the second energetic radiation is preferably within the range of 0.5-1000 microseconds. The directions of propagation of the first energetic radiation and the second energetic radiation can be substantially perpendicular to each other, in particular, at an angle of between 45 and 135 degrees between each other, for example. The first energetic radiation can be delivered in incident light, i.e., from a side of the sample support on which the sample material is deposited, or in transmitted light, i.e., from a side of the sample support that faces away from the side on which the sample material is deposited.

In various embodiments, a direction of incidence of the first energetic radiation can be changed relative to a surface normal of the sample support, and a plurality of impingement points aimed at. This method of operation accelerates the rastering of a sample support with sample material deposited over its surface, since changes in the beam orientation, e.g., using reflective optical elements such as galvanometric micromirrors, can be carried out a lot quicker and easier than by moving the very heavy translation stage on which the sample support is deposited and/or prepared together with the sample material. Movements of the translation stage are preferably carried out when the range of motion of the first energetic radiation over a predetermined finite area on the sample support is exhausted.

In various embodiments, the sample material can be prepared with a light-absorbent matrix substance. For the desorption, a MALDI method may be possible in incident light (in reflection mode) or in transmitted light (in transmission mode), depending on the requirements. The MALDI method requires a certain sample preparation with a light-absorbent matrix substance, e.g., sinapic acid, 2.5-dihydroxybenzoic acid, α-cyano-4-hydroxycinnamic acid or 2.5-dihydroxyacetophenone, all of which absorb strongly in the ultraviolet spectral range. A laser light from a nitrogen laser with a wavelength of around 337 nanometers is suitable for the first energetic radiation, for example, as is a laser light from a frequency-tripled solid-state Nd: YAG laser at around 355 nanometers. The second energetic radiation can comprise a laser light pulse with a wavelength of 266 nanometers, for example. For the second energetic radiation, all wavelengths below the two-photon limit can generally be used for the ionization of the matrix substance used, i.e., mostly wavelengths that are shorter than or equal to 290 nanometers for matrix substances with ionization energies of around eight electronvolts. The energy of the first energetic radiation is preferably in the range of 0.1-50 microjoules; the lower limit can be applied particularly in the case of small laser foci on the sample material, as can be set with transmission MALDI, for example. The energy of the second energetic radiation can be in the range of 100-600 microjoules, for example, with particular preference given to 300-500 microjoules.

In various embodiments, the first energetic radiation can be delivered using a transmitted light optical system that is positioned and designed so that the first energetic radiation is applied to the sample support from a backward direction after passing through the sample support. The embodiment as a transmitted light optical system makes it possible to keep the front desorption and ion formation area free from beam-guiding elements that could interfere with the ion extraction. The ion extraction from the ion formation area can be performed substantially linearly parallel to a surface normal of the sample support or can also comprise changes of direction, e.g., deflections by 90°, which may be triggered by suitably arranged deflection electrodes. Moreover, a transmitted light optical system allows greater focusing of the first energetic radiation for a spatially very limited ablation of the sample material, meaning that considerably higher spatial-lateral resolutions can be achieved compared to when using incident light optical systems, such as reflection MALDI. A laser beam can be used to achieve ablation surfaces, and therefore pixel surfaces, with diameters in the single-digit micrometer range and—with particularly careful fine adjustment—even in the submicrometer range, e.g., with a diameter of 0.5-5 micrometers.

In various embodiments, the sample material can have a plurality of spot preparations or a two-dimensional or flat tissue section. In particular, a microtomized tissue section can be used as sample material. Examples of this are brain tissue and retina tissue, e.g., from rodents. The sample material can, in particular, be taken from a frozen piece of tissue or formalin-fixed paraffin-embedded (FFPE) tissue, which may require additional processing steps prior to the analysis, e.g., “deparaffinization” and “de-crosslinking”, also known as antigen retrieval. The thickness of a tissue section for analysis can be 2-20 micrometers, or in particular, 2-15 micrometers for MALDI applications in transmitted light. For reflection MALDI, the sections may also be thicker, e.g., 2-40 micrometers. The analysis of tissue sections is becoming increasingly important, particularly in the area of clinical applications aimed at determining the pathological states of a tissue and differentiating them from non-pathological states, or the cell response to the administration of pharmaceutical substances. A plurality of spot preparations may, for example, comprise a dense field of 1536 or more individual preparations on the sample support, which have been produced using a dried-droplet method. Active substance candidate detection for pharmacological investigations, for example, is worth mentioning as an area of application.

In various embodiments, the sample support can comprise a glass plate, metal plate or ceramic plate. The surface of the sample support that carries the sample material is preferably designed to be electrically conductive so that it can form an electrical reference potential and allow and/or simplify the handling of the desorbed and ionized sample material. This design has a positive impact particularly in the case of axial extraction of the ionized sample material from the ion formation area, i.e., extraction that is substantially conducted parallel to a surface normal of the sample support. Suitable options include, for example, polished steel plates or plates with lyophilic anchor sites in a lyophobic environment such as the AnchorChips™ from Bruker. For the use of the first energetic radiation in transmitted light, glass specimen slides coated with indium tin oxide (ITO) can be used in particular.

In various embodiments, the first energetic radiation and/or the second energetic radiation can be delivered by a pulse laser or pulsed laser. In particular, the first energetic radiation can be applied to the sample in pulses. The clock-pulse rate of a pulse sequence can be in the range of a few hertz, e.g., 1-20 pulses per second, up to 10³ or 10⁴ Hz. A clock-pulse rate of the second energetic radiation can be matched to the clock-pulse rate of the first energetic radiation, and each individual desorption cloud can be irradiated with a suitable delay of a few microseconds, which enhances the formation of a desorption cloud, starting from the application of the first energetic radiation. The delay can be, for example, 0.5-100 microseconds, depending on the height of the direction of propagation plane above the sample support and on the pressure level, and can preferably be 5-20 microseconds, particularly under medium vacuum pressures of a few hectopascals and a height of the direction of propagation plane above the sample support of around 500 micrometers.

In various embodiments, the position of the sample support relative to the first energetic radiation and/or the direction of propagation of the second energetic radiation can be changed or re-aligned using one or more mirrors and/or one or more lenses. For the first energetic radiation, an optical arrangement with a Kepler telescope can be used, for example, as described in the patent publication DE 10 2011 112 649 A1 (corresponds to GB 2 495 805 A and US 2013/0056628 A1). For the second energetic radiation, the use of galvanometric micromirror pairs is preferred, with each micromirror able to be rotated around an axis of rotation in order to change the direction of emergence of a reflected beam. The use of at least one pair of flexible rotating mirrors makes it possible to change the beam orientation in a way that allows an almost parallel offset compared to a preset standard beam alignment, while simultaneously keeping the direction of propagation at one height above the sample material and sample support. This means that the alignment of the second energetic radiation can be quickly and reliably corrected to match the varying impingement points at the sample material on the sample support, so that optimal irradiation of a propagating desorption cloud is always achieved. By providing an additional pair of flexible rotating galvanometric mirrors with axes of rotation aligned perpendicularly to those of the other micromirrors, it is also possible to temporarily change, e.g., increase or decrease, the height of the direction of propagation of the second energetic radiation for a short period.

In various embodiments, the ion-processing device can be designed as an analyzer, and, in particular, as a mobility analyzer, mass analyzer, or coupled or hybrid mobility-mass analyzer. Ion-guiding intermediate stages, e.g., radio-frequency voltage ion guides such as rod multipoles or RF funnel arrangements. can be arranged upstream from the actual analyzer, or multiple analyzers in series, and also in different sections between such analyzers in series. Various analyzers and intermediate stages can also be operated at different vacuum levels.

An ion mobility analyzer separates charged molecules or molecular ions according to their collision cross-section to charge ratio, sometimes designated by σ/z or Ω/z. The basis for this is the interaction between the ionic species and an electric field that couples with the charge of the ions, and the simultaneous effect of a buffer gas that influences the average cross-sectional area of the ion. Already known are, particularly, drift-tube mobility separators with static electric field gradients, which drive ions through an essentially stationary gas. Here, the drift velocity of an ionic species is given by the propulsive force of the electric field and the decelerating force of the collisions with the gas particles. Equally common are trapping ion mobility separators (TIMS) with a continuous laminar gas flow driving the ions forward, said gas flow being counteracted by a gradually changed electric field gradient with correspondingly variable deceleration force. Traveling-wave mobility separators are also worthy of mention.

A mass analyzer, on the other hand, separates charged molecules or molecular ions according to their mass-to-charge ratio, usually designated as m/z. Time-of-flight analyzers can be used, for which both linear and reflector setups and/or setups with orthogonal acceleration into the flight region can be chosen. Other types of mass-dispersive separators can also be used, e.g., quadrupole mass filters (“single quads”), triple quadrupole analyzers (“triple quads”), ion cyclotron resonance cells (ICR), Kingdon-type analyzers such as the Orbitrap® (Thermo Fisher Scientific), and others. It is evident that analyzers and separators of the previously mentioned types can be coupled to enable ionic species to be separated multi-dimensionally, i.e., according to more than one physical-chemical property, such as m/z and σ/z or Ω/z.

In various embodiments, the focus position and/or beam waist position of the second energetic radiation can be re-aligned (i) perpendicularly to and/or (ii) along the direction of propagation of the second energetic radiation. The beam-waist position or focus position is preferably realized along the direction of propagation of the second energetic radiation using a lens system in the beam path that contains at least one movable optical lens that can be used to adjust the focal length settings of the entire optical system for the second energetic radiation. Regarding re-alignment perpendicularly to the direction of propagation of the second energetic radiation, pairs of galvanometric micromirrors are preferably used, which can each be rotated around a separate axis of rotation and which change a direction of emergence of the reflected second energetic radiation.

It may be expedient to change the height of the beam-waist position or focus position above the sample material and sample support if a very pronounced deflection of the first energetic radiation has been set in relation to a standard impingement point. As a result of the divergence of the second energetic radiation, a very pronounced deflection of the impingement point may bring about a risk of areas on the sample material and sample support coming into contact with peripheral areas of the second energetic radiation, thereby generating interfering background in the spectral data. Setting a temporarily and briefly greater height above the sample material and sample support for such extreme deflections allows a compromise to be reached between reducing this risk of forming ionic or chemical background in the spectral data and maintaining a favorable beam path of the second energetic radiation. It may also be advisable to temporarily set a lower height above the sample material and sample support for a short period, e.g., in order to place the interaction of the second energetic radiation and the desorbed sample material in an area of the desorption cloud where the particle density is so high that it significantly enhances charge carrier formation and charge carrier transfer to uncharged molecules in the cloud, which can bring about an increase in the yield of ionized desorbed sample material. Such an embodiment is also attributable to the invention.

According to an additional aspect, the present disclosure relates to a device for desorbing and ionizing of sample material deposited on a sample support, comprising: —a desorption device for generating and guiding the first energetic radiation; —an ionization device for generating and guiding the second energetic radiation; —a first adjustment device for setting and changing the position of the first energetic radiation relative to the sample support; —a second adjustment device for setting and re-aligning the focus position and/or beam waist position of the second energetic radiation; and a guidance system that communicates with the desorption device, the ionization device, the first adjustment device and the second adjustment device, and that is designed and programmed to coordinate and perform a method as described herein above.

### BRIEF DESCRIPTION OF THE ILLUSTRATIONS

The invention can be better understood by referring to the following illustrations. The elements in the illustrations are not necessarily to scale, but are primarily intended to illustrate the principles of the invention (mostly schematically). In the illustrations, the same reference numerals designate corresponding elements in the different views.

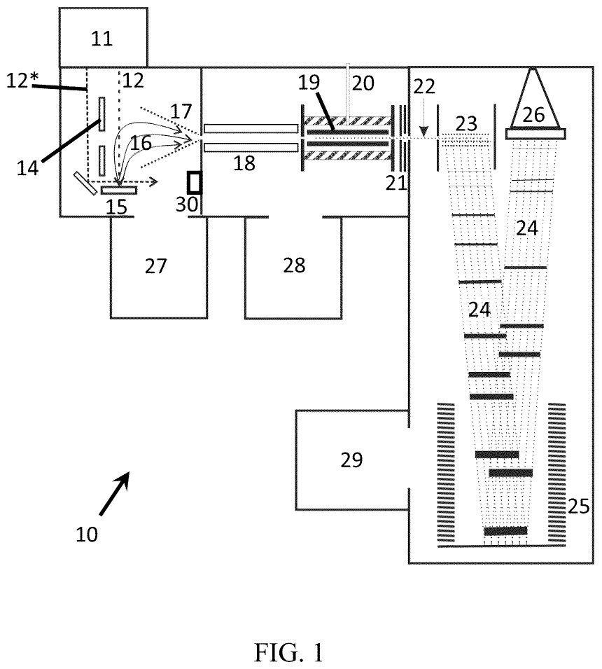

FIG. 1 is a schematic representation of the setup of an ion spectrometer with laser-assisted post-ionization carried out in its source section (adapted from DE 10 2016 124 889 A1, corresponding to GB 2 558 741 A and US 2018/0174815 A1).

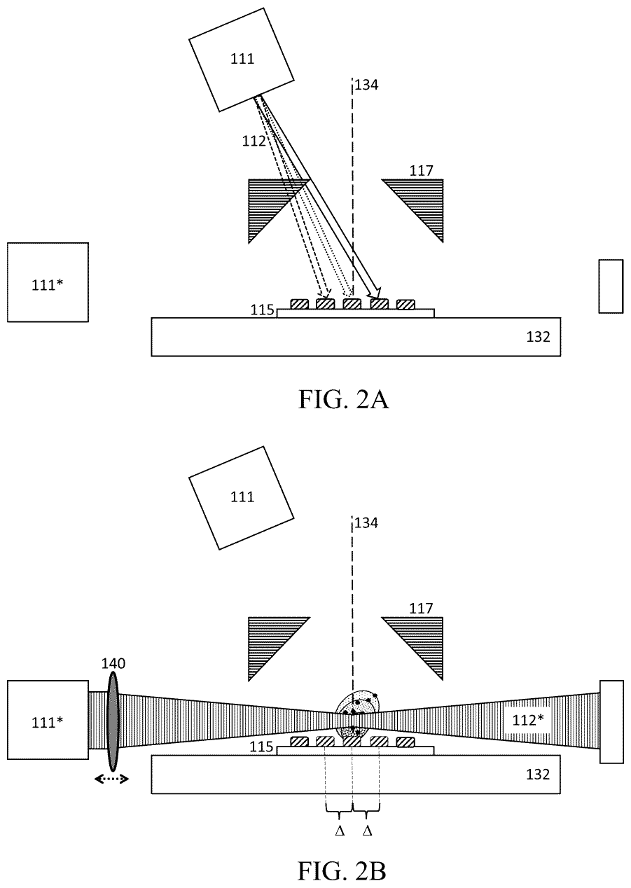

FIG. 2A is a schematic illustration of a type of operation of an ion source where a first energetic radiation is moved to different impingement and ablation points over a field of sample material that is deposited on a sample support.

FIG. 2B is a schematic representation of the ion source from FIG. 2A with activated post-ionization modality and the divergence of the impingement/ablation point and the focus position/beam waist position of the second energetic radiation.

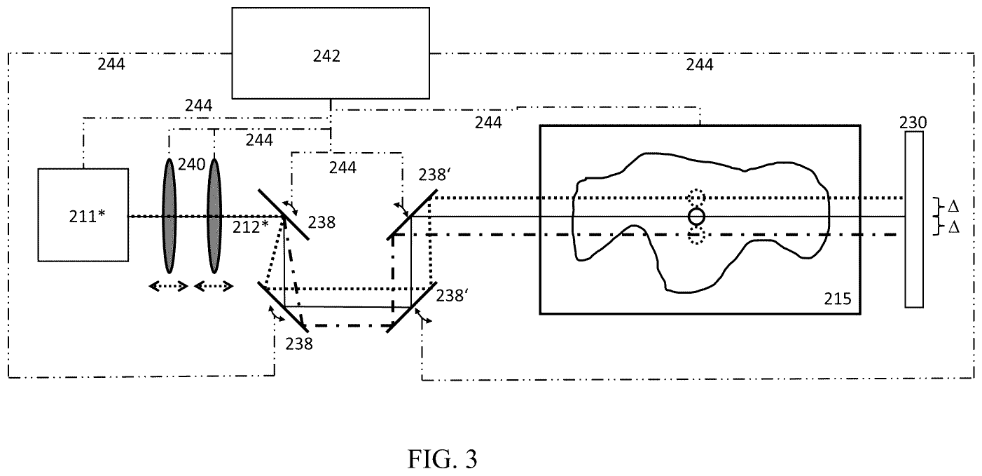

FIG. 3 is a schematic illustration of the adjustment of the direction of propagation of the second energetic radiation with an offset of the impingement and ablation points of the first energetic radiation perpendicular to the direction of propagation of the second energetic radiation.

### DETAILED DESCRIPTION

While the invention has been illustrated and explained with reference to a number of embodiments, those skilled in the art will recognize that various modifications in form and detail can be made without departing from the scope of the technical teaching, as defined in the attached claims.

FIG. 1 shows an ion spectrometer (10) that uses a post-ionization modality and in which principles of the present disclosure can be implemented, and serves the purpose of contextualization.

FIG. 1 is a simplified schematic representation. The standard operating mode with temporary storage and possible collision-induced dissociation of ions in the ion storage device (19) is as follows: In an ion source with laser system (11), ionized sample material (16) is generated from sample material on the sample support (15) by the first pulsed laser light beam (12), which enters the source through a window (not shown), and the ionized sample material is pushed into a conventional radio-frequency (RF) ion funnel (17) by a potential at the electrode (14). The impingement point of the first pulsed laser light beam (12) on the sample material can be varied within certain limits by changing the direction of delivery of the first pulsed laser light beam (12), as explained above. The ion generation can be assisted by a second pulsed laser light beam (12*), which is laterally focused, with synchronization, into the desorption cloud of ablated sample material propagating above the sample support (15) before the beam is received, away from the sample support (15), by a beam dump (30). The focus position and/or waist position of the second pulsed laser light beam (12*) is adapted such that it is positioned substantially opposite the current impingement point on the sample material in order to guarantee optimal interaction between the energy in the second pulsed laser light beam and the particles in the desorbed material cloud.

The ions then enter the RF quadrupole rod system (18), which can be operated both as a simple ion guide and as a mass filter to select a species of precursor ions to be fragmented. The unselected or selected ions are then fed into the RF quadrupole ion storage device (19) and can be fragmented by high-energy collisions according to their acceleration. The ion storage device (19) has a gastight casing and is charged with collision gas, such as nitrogen or argon, through the gas feeder (20) in order to focus the ions by means of collisions and to collect them in the axis.

At specified times, ions are extracted from the ion storage device (19) by a switchable extraction lens (21), which shapes the ions into a fine primary ion beam (22) and sends them to the ion pulser (23). The ion pulser (23) pulses out a section of the primary ion beam (22) orthogonally into the drift region, which is at a high electrical potential, thus generating the new ion beam (24). The ion beam (24) is reflected in the reflector (25) with velocity focusing and measured in the detector (26). The mass spectrometer is evacuated by connected pumps (27), (28) and (29).

FIG. 1 shows how ionized sample material that moves away from the sample support (15) on which the sample material is initially deposited, fundamentally along a surface normal of the sample support (15), is deflected by a deflection electrode (14) and—supported by the gas stream from the ion formation area in the medium vacuum to a downstream section kept at lower pressure—is guided into a connected ion guide, designed here as an RF funnel (17). Those skilled in the art will understand that this embodiment should not be considered limiting. An extraction direction of the ionized desorbed sample material that is substantially parallel to a surface normal of the sample support (15) is also conceivable. With regard to FIG. 1, this could mean that the sample support (15) is positioned substantially opposite the wide end of the RF funnel (17) (e.g., by moving the sample support 90° in a clockwise direction). The deflection electrode (14) could then be removed, or retained with a change of function by turning it into an extraction electrode and utilizing the central aperture. The beam paths of the first and second pulsed laser light beams (12, 12*), possibly with the removal and/or addition of suitable deflection mirrors, as well as the position of the beam dump (30) for the second pulsed laser light beam (12*) would need to be adapted accordingly in this type of modified embodiment.

FIGS. 2A and 2B are schematic representations, by way of example, of an ablation and desorption process in an ion source. A sample support (115), which in this example carries a plurality of individual preparations of sample material, is positioned on a translation stage (132). The translation stage (132) can be designed to adjust the position of the sample support (115) along up to three spatial axes xyz, of which two axes span an xy-plane perpendicular to the displayed plane, and the third axis z can run from bottom to top in the displayed plane. Nevertheless, the number of actual actuations of the translation stage (132) is rather small, since it is fundamentally very heavy, meaning that it takes a rather long time from performance of the movement to the subsiding of any vibrations generated during said movement. It is more advantageous to only move the translation stage (132) if sample material that is positioned outside of a predetermined finite area on the sample support (115) that can be covered with beam guidance tools needs to be exposed to a desorption beam (112). This mode of operation can be referred to as a hybrid or combined “stage scan”-“laser scan” approach.

A first laser system (111) is, in this example, positioned at an oblique angle above the translation stage (132) and is designed to direct a laser beam (112) onto predetermined locations within a predetermined finite area on the sample support (115) in different orientations (solid, dotted and dashed contours) without any movement of the translation stage (132), e.g., a design as reflection MALDI; the latter designation is derived from the fact that, in the broadest sense, the desorbed and ionized sample material leaves the sample support (115) against the direction of incidence of the first laser beam (112). The finite area can have a diameter or an edge length of 100-1000 micrometers, for example. A guiding element positioned above the sample support (115), such as the indicated RF ion funnel (117), is able to collect the desorbed and electrically charged sample material and to transfer it to a connected analyzer (not shown), via intermediate stages if necessary and/or using axial extraction or extraction with changes of direction. To this end, extracting electrical potentials can be either permanently or intermittently applied to the RF ion funnel (117), coordinated with the desorption pulses of the first energetic radiation (112).

Also shown is a post-ionization modality in the form of a second laser system (111*) positioned and designed so that a second laser beam (112*) can be laterally focused into a desorption cloud of sample material, e.g., according to the MALDI-2 method, see FIG. 2B. The contour and external dimensions of the second laser beam (112*) are not necessarily shown to scale here, particularly in relation to its divergence. In practice, it is a good idea for the user to ensure that the second, laterally incident laser beam (112*) maintains a sufficient distance from the surface of the sample support to prevent unintentionally brushing the sample support (115) or the sample material deposited on it, and to avoid the formation of background in the spectral data.

The alignment and focusing of the second laser beam (112*) is usually rigid and so cannot be changed or adapted without complex human intervention, meaning that there is just one optimal position for a desorption cloud in order for it to be optimally impacted by the second beam (112*). The aim here is always ionization, or at least an increase in the degree of ionization if the desorption process itself already involves ionization, as with a MALDI preparation. For this reason, the ablation or desorption location would always need to be moved to the fixed focus position or beam waist position of the second laser, which can only be achieved by moving the translation stage (132), which is slow and time-consuming, as indicated above. If a change is made to the alignment of the first laser beam (112) relative to the sample support (115), or rather to a surface normal (134) of the sample support (115), see FIG. 2A, the impingement and ablation location and the focus position or waist position of the second beam (112*) may no longer be optimally matched, and there may be effectiveness losses, e.g., because the second beam (112*) and the desorption cloud only overlap peripherally, or because a critical beam fluence for the interaction with the desorbed sample material is no longer achieved as a result of beam divergence. In an extreme case, with very pronounced deflection of the first beam (112) from a standard impingement point, the second beam (112*) could completely miss the desorption cloud which, as experience shows in the case of reflection MALDI with oblique beam incidence, does not propagate precisely along a surface normal (134) of the sample support (115), but slightly distorted against the direction of incidence of the first beam (112). The advantageous post-ionizing effect of the second beam (112*) would then of course fail to materialize.

FIGS. 2A and 2B are schematic representations, by way of example, of the problem with deflection of the first beam (112) onto impingement points in a row along the direction of propagation of the second beam (112*). In the case of a stationary translation stage (132), the first beam (112) is delivered onto different impingement points in three different angles of incidence relative to the sample support (115), see FIG. 2A. The focus position of the second beam (112*) is only substantially opposite the central section of the sample material and is therefore optimal; with deflection (4) to the right and to the left in FIG. 2B, the second beam (112*) does not meet the desorption cloud with its beam waist or its narrowest region, which in the vast majority of cases matches the focus position. This can lead to parts of the desorbed sample material failing to interact with the second beam (112*), or the fluence at the site of the interaction remaining below a critical threshold, meaning that the effect of the advantageous charge carrier increase cannot be achieved in full. It is necessary to adjust the focus position or beam waist position along the direction of propagation of the second beam (112*) in order to rectify this problem, e.g., using movable optical lenses positioned in the beam path (140). The lens (140) in FIG. 2B should be understood as a schematic placeholder. In its place, a more comprehensive lens system with multiple optical elements can be installed in order to change the beam waist position and/or focus position along the direction of propagation.

The situation is more serious if a change in alignment of the first energetic radiation (112) deflects the impingement point on the sample support (115) along a direction that is substantially perpendicular to the direction of propagation of the second beam (112*). In such a situation, the problem of complete spatial divergence of the second beam (112*) and the desorption cloud emerges a lot more quickly than does slipping out of focus in the case of deflection along the direction of propagation of the second beam (112*). This case is schematically represented by way of example in FIG. 3.

FIG. 3 shows a schematic plan view of the second laser system (211*), which produces the second energetic radiation (212*), on the left-hand side. At the opposite end of the diagram, on the right-hand side, there is a beam dump (230) that is designed to receive excess photonic energy and remove it from the set-up in order to prevent any interfering scattered light that could impair other components or assemblies, for example. The diagram also shows the sample support (215) with schematically highlighted impingement points indicating ablation and desorption sites of sample material, as well as an optical guidance system with pairs of mirrors (238, 238′) and imaging lenses (240). The sample material on the sample support (215) is sketched here as a tissue section. The beam path of the second beam (212*) in different settings is shown with solid, dotted and chain-dotted lines. The mirrors (238, 238′) are designed so that they can each be rotated around their own separate axis of rotation. The axis of rotation of the mirrors (238) is different to that of the mirrors (238′), and these axes of rotation are preferably arranged perpendicular to each other. The axes of rotation of the mirrors (238) may, for example, be perpendicular to the drawing plane, whereas the axes of rotation of the mirrors (238′) are in the drawing plane. The flexible rotating design of the mirrors (238) ensures that the direction of propagation of the second energetic radiation (212*) can be adjusted in a fixed plane parallel to the surface of the sample support (215) without having to change the height above the sample support (215). In turn, the flexible rotating design of the mirrors (238′) also enables the height of the beam plane above the sample support (215) to be adjusted. The surface of the mirrors (238, 238′) is dimensioned such that different angular deflections of the second beam (212*) can be translated into a spatial offset (4) to the beam axis along two spatial directions that are aligned perpendicularly to the general direction of propagation of the second energetic radiation (212*). The lens system (240) can also have a plurality of imaging lenses (240), at least one of which can be moved in the direction of propagation of the second beam (212*). This makes it possible to adjust the focus position or waist position of the second beam (212*) above the sample support (215) in the direction of propagation of the second beam (212*) along the three spatial directions, as explained above in relation to FIGS. 2A and 2B.

A guidance system (242) communicates with the adjustment device (not shown) of the sample support (215), the second laser system (211*), the adjustment device of the first beam (not shown), the pairs of mirrors (238, 238′) and the lens system (240), and coordinates their operation so that the impingement and ablation point on the sample support (215) and the waist position or focus position of the second beam (212*) are always located substantially opposite one another. Communication is indicated by the double-chain-dotted lines (244).

Principles of the invention make it possible to enlarge, in particular, the areas on the sample material that can be impacted by simply adjusting the first energetic radiation, without having to move the heavy and slow translation stage on which the sample support is located. This allows the setting of larger deflections in the beam guide of the first energetic radiation. This can help to accelerate the spatially resolved processing of a sample support on which sample material is deposited, compared to methods known from the Prior Art, since the total number and frequency of the sample support movements required for rastering can be reduced still further.

The invention has been described above with reference to different, specific example embodiments. It is to be understood, however, that various aspects or particulars of the embodiments described can be modified without deviating from the scope of the invention. Furthermore, the features and measures disclosed in connection with different embodiments can be combined as desired if this appears practicable to a person skilled in the art. Moreover, the above description serves only as an illustration of the invention and not as a limitation of the scope of protection, which is exclusively defined by the appended Claims, taking into account any equivalents which may exist.

1. A method for desorbing and ionizing of sample material which is deposited on a sample support, comprising:
repeatedly locally impacting sample material on the sample support using a first energetic radiation and triggering of local desorption of sample material into a gas phase above the sample support, while varying a position of the first energetic radiation relative to the sample support and aiming at a plurality of impingement points on the sample material on the sample support;
impacting locally desorbed sample material using a pulsed second energetic radiation, which is aimed into the locally desorbed sample material, and triggering of ionization and/or increasing a degree of ionization of the locally desorbed sample material, with a direction of propagation of the second energetic radiation being in a plane that is substantially perpendicular to a surface normal of the sample support and positioned above the sample support, and with a focus position and/or beam waist position of the second energetic radiation being aligned such that it is positioned substantially opposite a current impingement point at the sample material on the sample support; and
transferring ionized sample material, originating from the locally desorbed sample material which has been impacted with the second energetic radiation, into an ion-processing device.

2. The method according to claim 1, wherein a direction of incidence of the first energetic radiation is changed relative to a surface normal of the sample support.

3. The method according to claim 1, wherein the sample material has been prepared using a light-absorbent matrix substance.

4. The method according to claim 1, wherein the sample material comprises a plurality of spot preparations or a two-dimensional tissue section.

5. The method according to claim 1, wherein the sample support comprises a glass plate, metal plate or ceramic plate.

6. The method according to claim 1, wherein the first energetic radiation and/or the second energetic radiation is delivered by a pulse laser.

7. The method according to claim 1, wherein the position of the first energetic radiation and/or the direction of propagation of the second energetic radiation relative to the sample support is changed or re-aligned using one or more mirrors and/or one or more lenses.

8. The method according to claim 1, wherein the ion-processing device comprises a mobility analyzer, mass analyzer, or a coupled mobility-mass analyzer.

9. The method according to claim 1, wherein the focus position and/or beam waist position of the second energetic radiation is aligned (i) perpendicularly to and/or (ii) along the direction of propagation of the second energetic radiation.

10. A device for desorbing and ionizing sample material which is deposited on a sample support, comprising:
a desorption device for generating and guiding the first energetic radiation;
an ionization device for generating and guiding the second energetic radiation;
a first adjustment device for setting and changing the position of the first energetic radiation relative to the sample support;
a second adjustment device for setting and aligning the focus position and/or beam waist position of the second energetic radiation; and
a guidance system that communicates with the desorption device, the ionization device, the first adjustment device and the second adjustment device, and that is programmed to coordinate and perform a method according to claim 1.
